(19) United States
(12) Patent Application Publication
(10) Pub. No.: US 2024/0158047 A1
(43) Pub. Date: May 16, 2024

(54) DRIVE UNIT FOR AN ELECTRIC BICYCLE HAVING A GEARING SUPPORT FOR MOUNTING GEARS OF TWO GEARING STAGES

(71) Applicant: BROSE ANTRIEBSTECHNIK GMBH & CO. KOMMANDITGESELLSCHAFT, BERLIN, Berlin (DE)

(72) Inventors: Christian BRÜGGEMANN, Berlin (DE); Mick JORDAN, Brieselang (DE); Peter TENBERGE, Bochum (DE); Kevin ZYSKA, Hattingen (DE); Richard FRIZLER, Witten (DE)

(21) Appl. No.: 18/550,053

(22) PCT Filed: Mar. 11, 2022
(86) PCT No.: PCT/EP2022/056283

§ 371 Date: Sep. 11, 2023

(30) Foreign Application Priority Data
Mar. 16, 2021 (DE) 10 2021 202 574.9

(51) Int. Cl. B62M 11/14; B62M 6/55

(52) U.S. Cl. CPC B62M 11/145; B62M 6/55

(57) ABSTRACT

Is it provided a drive unit for an electric bicycle, comprising
an electric motor with a motor shaft for externally power-operated generation of an additional driving torque by external force,
a gearing device for coupling a motor shaft of the electric motor to an output shaft, wherein the gearing device comprises at least two gear stages, and
a housing accommodating the electric motor and the gearing device.

The drive unit comprises a gearing support fixed in the housing), on which gearing support at least one gear wheel of a first gear stage and at least one gear wheel of a second gear stage are rotatably mounted.

### BACKGROUND

The proposed solution relates to a drive unit for an electric bicycle.

It is known to use at least one electric motor in combination with a gearing device including a planetary gear stage on an electric bicycle, hence on a so-called e-bike or pedelec, in order to provide support by a motor when riding the electric bicycle. A corresponding drive unit on the one hand includes a drive shaft (typically also referred to as a bottom bracket shaft) via which a driving torque generated by a rider of the electric bicycle can be introduced and on which pedals are provided therefor. Via an output shaft of the drive unit to be coupled with a wheel of the electric bicycle a torque generated by an electric motor and hence by external force in addition to a driving torque introduced at the drive shaft by muscle force can be transmitted to a wheel, usually a rear wheel of the electric bicycle. Via the gearing device of the drive unit, the at least one electric motor and the output shaft are coupled to each other.

### SUMMARY

In drive units for electric bicycles, in particular drive units for so-called mid-mounted motors, there still is a demand for an accommodation of the components of the drive unit optimized in terms of installation space and for a reduced weight of the drive unit.

Against this background, the drive unit as described herein is proposed.

A proposed drive unit for an electric bicycle at least comprises
a drive shaft for muscle-powered generation of a driving torque,
an output shaft for driving a wheel of the electric bicycle, the output shaft being is arranged coaxially to the drive shaft,
an electric motor with a motor shaft for externally power-operated generation of an additional driving torque,
a gearing device for coupling a motor shaft of the electric motor to the output shaft, wherein the gearing device comprises at least two gearing stages, and
a housing accommodating the electric motor and the gearing device.

Furthermore, it is provided that the drive unit comprises a gearing support fixed in the housing, on which gearing support at least one gear wheel of a first gear stage and at least one gear wheel of a second gear stage are rotatably mounted.

In the proposed drive unit, a gearing support thus is fixed in a housing of the drive unit, on which gear wheels of different gear stages are rotatably mounted. The gearing support thus fulfills several functions, whereby installation space, weight and costs can be reduced.

For rotatably mounting the first gear wheel, an anti-friction or plain bearing for example is held in the bearing opening of the gearing support. During the assembly of the drive unit, a corresponding anti-friction bearing or plain bearing consequently can be mounted to the gearing support.

In one embodiment, the first gear wheel includes a first bearing portion, extending axially with respect to an axis of rotation of the first gear wheel, which first bearing portion protrudes into the bearing opening of the gearing support and on which an anti-friction or plain bearing held in the bearing opening is provided. The axially extending first bearing portion can be formed for example by a sleeve-shaped axial tab on the first gear wheel.

Alternatively or additionally, the first gear wheel can include a second bearing portion extending axially with respect to an axis of rotation of the first gear wheel, which second bearing portion in addition is rotatably mounted on a portion of a housing of the drive unit. On the housing, a bearing seat for an additional anti-friction or plain bearing consequently can be provided for rotatably mounting the first gear wheel via the second bearing portion.

For mounting the second gear wheel, the gearing support for example includes a bearing pin. On this bearing pin, an anti-friction or plain bearing can be provided for rotatably mounting the second gear wheel. In one embodiment, for example, an inner race of an anti-friction bearing provided on the bearing pin is non-rotatably fixed to the bearing pin. In a development based thereon, such inner race protrudes into a (second) bearing seat of a housing outer wall of a housing of the drive unit, which is formed on the side of the interior space. A corresponding engagement of the inner race of the anti-friction bearing here can serve to additionally stabilize the gearing support in operation of the drive unit and to facilitate the proper (pre-) positioning of the bearing pin within an interior space of the housing during the assembly.

Alternatively or additionally, the gearing support can be plate-shaped. The gearing support consequently is a separate, plate-shaped component which during the assembly of the drive unit is fixed to a housing part of the housing, for example via several (at least two) fastening elements, such as screws or bolts. In one embodiment, a bearing pin for the second gear wheel can be formed on such a plate-shaped gearing support to protrude in the direction of a housing outer wall of the housing.

Such a bearing pin protruding in the direction of a housing outer wall for example provides for a separate fixation of the bearing pin on the housing outer wall for additionally supporting forces acting on the bearing pin via the second gear wheel in operation of the drive unit. In this connection, one embodiment variant provides that the bearing pin protruding in the direction of the housing outer wall is fixed to the housing outer wall via an arresting element accessible from outside the housing. During the assembly of the drive unit, such an arresting element can thus be attached to the housing outer wall from outside in order to fix the bearing pin of the gearing support present within the housing to the housing outer wall and hence additionally support the same on the housing outer wall. An arresting element can be detachable, for example. For example, an arresting element is formed by a (bearing) screw. A corresponding bearing screw then for example is turned into a bore of the bearing pin from outside the housing through a through opening provided on the housing outer wall.

In one embodiment, the gearing support includes a bearing opening for rotatably mounting a gear shaft connected to the first gear wheel. This gear shaft arranged for example coaxially to the motor shaft forms part of a first gear stage which cooperates with the motor shaft of the electric motor and from which a torque is to be transmitted to the second gear stage in the direction of the output shaft. Consequently, the first gear wheel can be non-rotatably fixed to the gear shaft.

In one embodiment, the gear shaft in addition is rotatably mounted on a portion of a housing of the drive unit. Here, the gear shaft consequently is rotatably held and supported via two bearings, on the one hand via a bearing on the gearing support and on the other hand via a bearing on the housing. For example, a bearing seat for an additional anti-friction or plain bearing is provided on the side of the interior space of the housing (i.e. within an interior space of the housing) for rotatably mounting the gear shaft. Via such an additional anti-friction bearing or plain bearing on the housing-side bearing seat, the shaft end of the gear shaft then for example is rotatably mounted. Such a configuration can facilitate the assembly of the drive unit and in particular the arrangement of the gearing device within the housing of the drive unit.

In one embodiment, the gearing device includes a planetary transmission with a sun gear, a ring gear and a plurality of planetary gears rotatably mounted on a planet carrier of the planetary transmission. Here it is provided, for example, that the motor shaft of the electric motor is connected to the sun gear of the planetary transmission, and via the stationary ring gear a torque can be transmitted from the motor shaft to the planet carrier. An above-mentioned gear shaft, which is non-rotatably connected to the first gear wheel, then for example forms part of the rotatable planet carrier.

In addition, the gearing device can comprise a spur-gear transmission with first, second and third spur gears for transmitting a torque (resulting from the torque generated by the electric motor on the motor shaft) from the planetary transmission to the output shaft. A first spur gear here forms the first gear wheel and can be driven by the planetary carrier. A second spur gear of the spur-gear transmission forms the second gear wheel and meshes with the first spur gear and the third spur gear. The third spur gear in turn is connected to the output shaft in order to provide the additional driving torque.

Thus, in such a drive unit the motor shaft of the electric motor drives the sun gear of the planetary transmission, and by means of a stationary ring gear of the planetary transmission a torque is transmitted to the planet carrier and from the same to the first gear wheel in the form of the first spur gear of the additionally provided spur-gear transmission. Via the first spur gear to be driven by the planet carrier and the second gear wheel in the form of the second spur gear meshing with the first spur gear and the third spur gear, the additional driving torque is provided on the third spur gear connected to the output shaft. Thus, such a drive unit comprises a three-stage transmission with comparatively few transmission components, whereby a compact and comparatively lightweight drive unit can be provided for an electric bicycle. An axis of rotation of the motor shaft, an axis of rotation of the sun gear, an axis of rotation of the planet carrier and an axis of rotation of the first spur gear here are arranged coaxially and define a first shaft train with an associated first gear stage axis of rotation. What extends parallel thereto is a second gear stage axis of rotation of a second shaft train of the gearing device, which is defined by an axis of rotation of the second spur gear. An axis of rotation of the third spur gear and the axes of rotation of the drive shaft and of the output shaft extending coaxially thereto define a third gear stage axis of rotation of a third shaft train, which extends parallel to the first and second gear stage axes of rotation.

In a three-stage construction of the gearing device of the drive unit, a higher total rigidity of the drive unit can be achieved as compared to previously known solutions. At the same time, an easy assembly can be realized with low assembly forces and an improved adjustability of tolerance-related reference dimensions. The proposed solution, however, is not limited to a drive unit comprising a three-stage gearing device, in particular not to a gearing device with planetary transmission and spur-gear transmission.

In an embodiment comprising a gearing device with planetary transmission and spur-gear transmission, the gearing support is provided for rotatably mounting the planet carrier and the second spur gear. Hence, the planet carrier and the second spur gear then are rotatably mounted on the gearing support. Thus, the gearing support here performs both the support of the planet carrier of the planetary transmission and the support of the second spur gear of the spur-gear transmission. For example, a bearing opening of the gearing support here is provided for rotatably mounting a gear shaft of the planet carrier, which is connected to the first spur gear. This gear shaft coaxially arranged to the motor shaft for example is formed on the planet carrier. The first spur gear is non-rotatably fixed to the gear shaft, in order to transmit a torque from the planetary transmission to the spur-gear transmission.

Via an anti-friction or plain bearing held on a first bearing portion of the first spur gear, both the gear shaft and the first gear wheel then can be rotatably mounted and supported on the gearing support. Thus, the axially extending first bearing portion for example can be formed by a sleeve-shaped axial tab on the spur gear, through which the gear shaft of the planet carrier extends.

For example, a bearing seat is provided on the housing for rotatably mounting the gear shaft of the planet carrier. For this purpose, the gear shaft can also be non-rotatably accommodated in a second bearing portion of the first gear wheel, which is formed by a sleeve-shaped axial tab on the first gear wheel. In this way, an anti-friction bearing or plain bearing held in the bearing seat of the housing can be provided on the second bearing portion, in order to rotatably mount both the second gear wheel and the gear shaft on the housing-side bearing seat.

In principle, the output shaft and the drive shaft can be coupled to each other via a freewheel. This for example allows free pedaling by a user of the electric bicycle from a specified maximum speed for the electric bicycle (of for example 25 km per hour). Moreover, the output shaft can be connected both to a chain ring and to a belt wheel for driving the wheel of the electric bicycle.

In one embodiment, a total gear ratio in the range of 22 to 27 is provided via the gearing device. For example, a total gear ratio between the electric motor and the output shaft is about 25.

To reduce operating noise in operation of the drive unit, gear wheels of the gearing device meshing with each other can be helically toothed.

In an embodiment with a gearing device comprising a planetary transmission, in particular the planetary transmission can be accommodated in the housing of the drive unit and the stationary ring gear can be mounted in said housing. To further reduce the installation space needed for the gearing device and to also reduce a distance of the axis of rotation of a first gear stage with the rotating planet carrier and the first gear wheel to the axis of rotation of the second gear stage with the second gear wheel, the stationary ring gear of the planetary transmission, with respect to an axis of rotation of the sun gear, in one embodiment merely partly is radially supported by the housing on the side of the circumference. Hence, in such a embodiment no completely circumferential radial support of the stationary ring gear on portions of the housing is provided on the side of the circumference. Rather, no housing-side support deliberately is provided on at least one portion of the ring gear, which is arranged radially in the direction of the second gear stage axis of rotation. Since in this area no supporting housing portion must be provided correspondingly, the first and second gear stage axes of rotation can be arranged within the housing with a smaller distance to each other. A portion of the ring gear without radial support by the housing, which thus is cantilevered, in the present case is also referred to as a support portion.

In one embodiment, such a support portion of the ring gear protruding radially to the outside (in the direction of the second gear stage axis of rotation) and cantilevered, with respect to a support in a radial direction, is accommodated in a cutout of the housing. This cutout can be provided in a circumferential bearing edge of a bearing seat of the housing, which is configured for positively mounting the stationary ring gear. For example, the ring gear is fixed in this bearing seat via a press fit. In the bearing edge of the bearing seat, which does not completely circumferentially extend around the ring gear, a cutout then is formed, into which the support portion of the ring gear engages. By a positive engagement of the support portion into the cutout of the housing, an additional anti-rotation protection can be provided for the ring gear, and the ring gear can be non-rotatably held on the housing (with respect to the axis of rotation of the sun gear).

Alternatively or additionally, a circumferentially extending edge of the ring gear can be locally thickened on the cantilevered support portion of the ring gear. In the region of the support portion, on which no radial support by the housing is provided, an outside diameter of the ring gear consequently is locally increased in such a embodiment. The local thickening on the support portion then for example is dimensioned such that on the entire circumference of the ring gear the same component rigidity is achieved.

To further reduce the total weight of the drive unit, the ring gear can be made of aluminum. Alternatively, a manufacture of the ring gear with a metal core and an internal toothing made of a plastic material can also be provided. The ring gear then for example includes a metal core (partly or completely) overmolded with plastic material, for example a steel core. Then, the metal core consequently is embedded in the plastic material forming the internal toothing of the ring gear.

In one embodiment, the housing includes two housing parts connected to each other along a separating plane. The housing of the drive unit here can also comprise exactly two housing halves and hence be of two-part construction. A two-part construction facilitates the assembly and typically leads to a lower weight of the drive unit than for example with a construction of the housing of at least three housing parts.

In one embodiment, a bearing shield with a bearing opening is provided on the separating plane of the two housing parts for rotatably mounting the motor shaft of the electric motor. Such a bearing shield then for example extends parallel to the separating plane as a plate-shaped component and hence provides a bearing seat for rotatably mounting the motor shaft of the electric motor.

In a possible development, the bearing shield additionally includes at least one centering portion for centering the two housing parts of the housing with respect to the motor shaft. The bearing shield consequently also performs the function of an alignment aid for correctly positioning the two housing parts relative to each other during the assembly of the drive unit. Hence, an additional function is integrated into the bearing shield, which in drive units known so far from practice typically is performed by separate cylinder pins. By means of the at least one centering portion on the side of the bearing shield, the housing parts thus can be centered relative to each other during the assembly of the drive unit. By means of the at least one centering portion on the side of the bearing shield, the housing parts are properly aligned relative to each other in particular on closing of the housing, before a subsequent fixation of the two housing parts to each other is effected, for example at predefined screw points of the housing. The parallelism and proper arrangement of the shaft trains of the drive unit can also be ensured thereby.

For example, the centering portion on the side of the bearing shield is at least partly positively accommodated on a centering shoulder of a first housing part of the two housing parts and on a centering shoulder of a second housing part of the two housing parts. The centering shoulders of the two housing parts can each be formed on an inner surface of a housing outer wall facing an interior space of the housing. The centering portion for example can be positively accommodated on the centering shoulders of the two housing parts in merely one alignment of the two housing parts relative to each other. For example, the centering portion therefor is designed to axially protrude, with respect to the axis of rotation of the motor shaft, and extends along a circular path (in the mounted state along a circular path around the axis of rotation of the motor shaft). Thus, the centering portion can be configured for example as an axially protruding (on both sides) circular ring portion on the bearing shield.

The bearing shield can be press-fitted at the two housing parts via an interference fit, in order to thereby ensure a safe arrestment of the bearing shield on the housing parts after the assembly of the drive unit.

In one embodiment, the bearing shield additionally integrates a cooling shield for dissipating heat from the interior space of the housing to a housing outer wall. Thus, the bearing shield additionally is provided for a heat dissipation of heat produced in the interior space of the housing to the outside.

For example, the bearing shield can be arranged adjacent to a board (circuit board) of the drive unit in an interior space of the housing. With respect to an axis of rotation of the motor shaft, the bearing shield then for example follows the board in an axial direction. The bearing shield also can at least sectionally rest against the board. A corresponding arrangement of the board relative to the bearing shield can be advantageous in particular when the bearing shield also integrates a cooling shield. In this way, heat can be dissipated via the bearing shield from the board and electronic components arranged thereon, which are provided for example for controlling the electric motor, to the outside. The board can extend parallel to the separating plane of the two housing parts. This also allows to further simplify the assembly of the drive unit, as during the assembly the board thereby can be positioned on an open side of a housing part.

In one embodiment, electronic components arranged on the board for controlling the electric motor comprise at least one sensor for electronically determining a position of the motor shaft with respect to a stator of the electric motor. The at least one sensor here can be arranged on the board at a radial distance to the motor shaft with respect to the axis of rotation of the motor shaft. The corresponding embodiment consequently provides a laterally arranged so-called off-axis sensor for electronically determining the position of the motor shaft with respect to the stator of the electric motor.

To utilize an installation space provided within the housing as efficiently as possible, the bearing shield, which is arranged adjacent to the board, can include several (at least two) cutouts, for example in the form of through openings, for electronic components arranged on the board. In this way, possibly thicker electronic components can protrude into cutouts of the bearing shield or extend through the same.

Moreover, the proposed solution also comprises an electric bicycle with an embodiment of a proposed drive unit.

### BRIEF DESCRIPTION OF THE DRAWINGS

The attached Figures by way of example illustrate possible embodiments of the proposed solution.

FIG. 1 sectionally and in a sectional view shows an embodiment of a proposed drive unit for an electric bicycle with a view to an electric motor and a planetary transmission as well as parts of a spur-gear transmission of the drive unit.

FIG. 2 shows a perspective view of individual parts of the drive unit without a housing accommodating the same for illustrating the cooperation of the electric motor via a gearing device comprising the planetary transmission and the spur-gear transmission with an output shaft of the drive unit.

FIG. 3 shows another sectional view of the drive unit by illustrating merely one of two housing parts of the housing of the drive unit.

FIG. 4 shows the one housing part also illustrated in FIG. 3 with elements of the planetary transmission and the spur-gear transmission accommodated therein.

FIG. 5 shows a perspective view of the other housing part, which is not shown in FIGS. 3 and 4, with a view to a board accommodated in the housing and a bearing shield arranged in a separating plane between the two housing parts.

### DETAILED DESCRIPTION

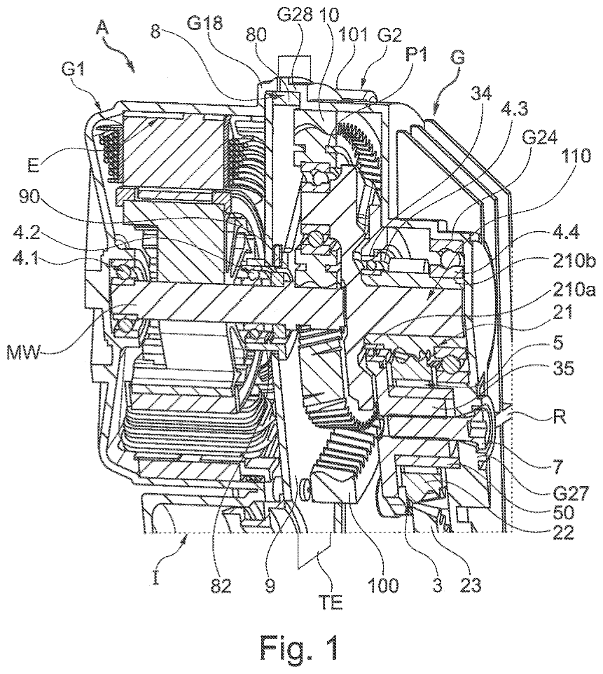

In a synopsis, FIGS. 1 to 5 show an embodiment of a drive unit A for an electric bicycle. The drive unit A for example is to be provided on an electric bicycle as a so-called mid-mounted motor. Via the drive unit A an additional driving torque, which is provided by an electric motor E of the drive unit A, is provided to an output shaft AT. The output shaft AT then for example is connected to a sprocket or belt wheel in order to provide an output torque at a wheel of an electric bicycle.

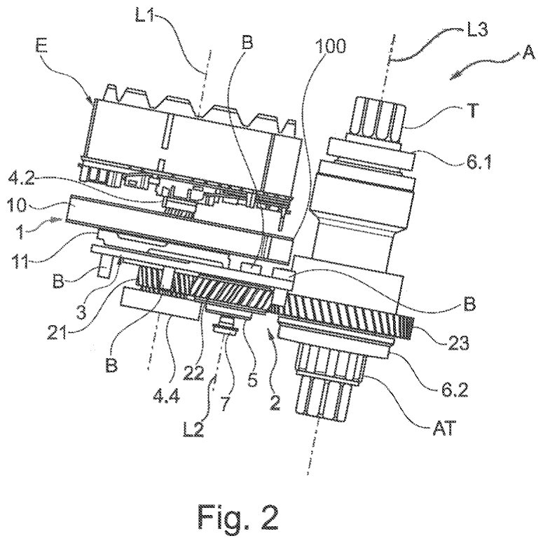

As shown for example in FIG. 2, the output shaft AT is arranged coaxially to a bottom bracket shaft T in a manner known per se. At shaft ends of this bottom bracket shaft T, which extends through a housing G of the drive unit A, pedals are provided in the state properly mounted to the electric bicycle. A rider of the electric bicycle thereby can introduce a driving torque into the bottom bracket shaft T by muscle force. In operation of the drive unit A, this driving torque generated by muscle force is provided at the output shaft AT together with an additional driving torque generated by external power from the electric motor E. The output shaft AT is coupled to the bottom bracket shaft T via a freewheel, which provides for freely pedaling from a specified maximum speed of the electric bicycle, of for example 25 km per hour.

To provide the additional driving torque from the electric motor E at the output shaft AT of the drive unit A, the drive unit A includes a three-stage gearing device with a planetary transmission 1 and a spur-gear transmission 2. The planetary transmission 1 and the spur-gear transmission 2 are accommodated completely within the housing G.

The planetary transmission 1 includes a sun gear S, a stationary ring gear 10 fixed in the housing G, and a plurality of planetary gears P1, P2 and P3 rotatably mounted on a planet carrier 11 of the planetary transmission 1. The sun gear S and the planet carrier 1 are rotatably mounted about a first gear stage axis of rotation L1 and hence form part of a first shaft train of the three-stage gearing device 1, 2. A motor shaft MW of the electric motor E is arranged coaxially to the sun gear S and a gear shaft 110 of the planet carrier 11. Thus, the motor shaft MW of the electric motor E likewise is rotatable about the first gear stage axis of rotation L1. The sun gear S is non-rotatably connected to one end of this motor shaft MW so that the motor shaft MW of the electric motor E drives the sun gear S and transmits a torque to the planet carrier 11 and its gear shaft 110 via the stationary ring gear 10.

A first spur gear 21 of the spur-gear transmission 2 is non-rotatably connected to the gear shaft 110 of the planet carrier 11. This first spur gear 21 meshes with a second spur gear 22, which as an intermediate gear of the spur-gear transmission 2 is arranged between the first spur gear 21 and a third spur gear 23 of the spur-gear transmission 2, which is non-rotatably connected to the output shaft AT. The second spur gear 22 is rotatably mounted about a second gear stage axis of rotation L2 in the housing G and thus defines a second shaft train. The third spur gear 23 of the spur-gear transmission 2 in turn is rotatable about a third gear stage axis of rotation L3 together with the output shaft AT and hence forms part of a third shaft train of the drive unit A. The bottom bracket shaft T arranged coaxially to the output shaft AT then is also rotatable about this third gear stage axis of rotation L3.

Via the planetary transmission 1, a gear ratio of −9 from the motor shaft MW to the gear shaft 110 and hence to the first spur gear 21 can be realized. The entire gearing device 1, 2 comprising planetary transmission 1 and spur-gear transmission 2 reaches a gear ratio of about 25.

As is illustrated in particular with reference to the sectional representation of FIG. 1, the housing G in the present case is composed of two housing halves G1 and G2, which are connected to each other along a separating plane TE. The housing G of the illustrated drive unit A correspondingly is of two-part construction. The two housing halves G1 and G2 here are centered with respect to each other via a bearing shield 8 arranged on the separating plane TE and hence are properly aligned relative to each other and with respect to the gear stage axes of rotation L1, L2 and L3 (and hence in particular to the axis of rotation of the motor shaft MW) during the assembly of the drive unit A. For such centering, the bearing shield 8 arranged on the separating plane TE includes a centering portion in the form of a centering collar 80, which in the manner of a circular ring portion extends along a circumferential edge of the bearing portion 8. With respect to the gear stage axis of rotation L1, the centering collar 80 protrudes from the bearing shield 8 on both sides axially and hence in the direction of both housing halves G1 and G2. In this way, the centering collar 80 can be positively accommodated in mutually opposite centering shoulders G18 and G28 of the two housing halves G1 and G2. The centering shoulders G18 and G28 are each formed as recessed depressions on an inside of an edge portion of the respective housing half G1 or G2.

In addition to a centering function, the bearing shield 8 in the assembled state of the drive unit A also performs a bearing function for the motor shaft MW of the electric motor E within an interior space I of the housing G. The bearing shield 8 includes a bearing opening 82 in which an anti-friction bearing 4.2, here in the form of a ball bearing, is held for rotatably mounting the motor shaft MW. The bearing shield 8 here is arranged between the electric motor E and the shaft end of the motor shaft MW carrying the sun gear S.

At a shaft end of the motor shaft MW facing away from the sun gear S, the motor shaft MW is rotatably mounted on a bearing seat of the one housing half G1, which is formed on the side of the interior space, via a further anti-friction bearing 4.1, here likewise in the form of a ball bearing.

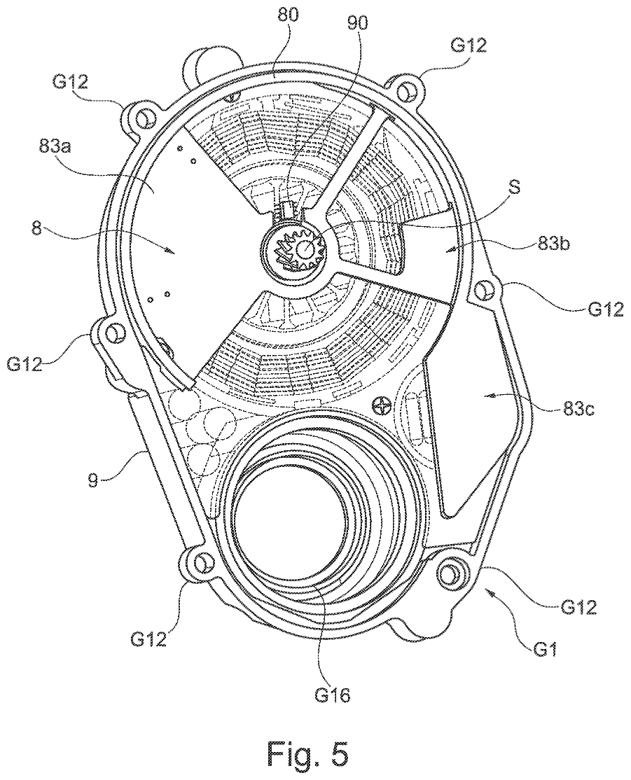

Between the bearing shield 8 and the electric motor E a board 9 furthermore is arranged in the region of the separating plane TE. The bearing shield 8 adjoins the board 9. To selectively dissipate heat of electronic components of the board 9 from the interior space I outwards to the housing wall of the housing G via the bearing shield 8, the bearing shield 8 additionally integrates the function of a cooling shield. As can be taken in particular from the side view of FIG. 5, the bearing shield 8 includes a plurality of surface portions 83a, 83b and 83c for dissipating and forwarding heat. In addition, a plurality of cutouts in the form of through openings are provided on the bearing shield 8, into which electronic components of the board 9 can protrude.

In one of the cutouts of the bearing shield 8 a sensor 90 of the board 9 also is accommodated. This sensor serves the determination of a rotor-stator position and hence a determination of the position of the motor shaft MW relative to a stator of the electric motor E for electronically controlling the electric motor E in operation of the drive unit A. In the present case, the sensor 90 is configured as an off-axis sensor and spaced radially from the motor shaft MW (with respect to the axis of rotation of the motor shaft MW) and hence arranged laterally.

The sun gear S of the planetary transmission 1 is driven by the motor shaft MW extending through the board 9 and the bearing shield 8, as already explained above, so that via the planetary gears P1, P2 and P3, which are meshing with an internal toothing 101 of the stationary ring gear 10 and the external toothing of the sun gear S, the planet carrier 11 and its gear shaft 110 can be put into rotation. While the electric motor E is arranged in the one (first) housing half G1, the planetary transmission 1 and the spur-gear transmission 2 are accommodated in the other (second) housing half G2. The ring gear 10 is press-fitted in the second housing half G2.

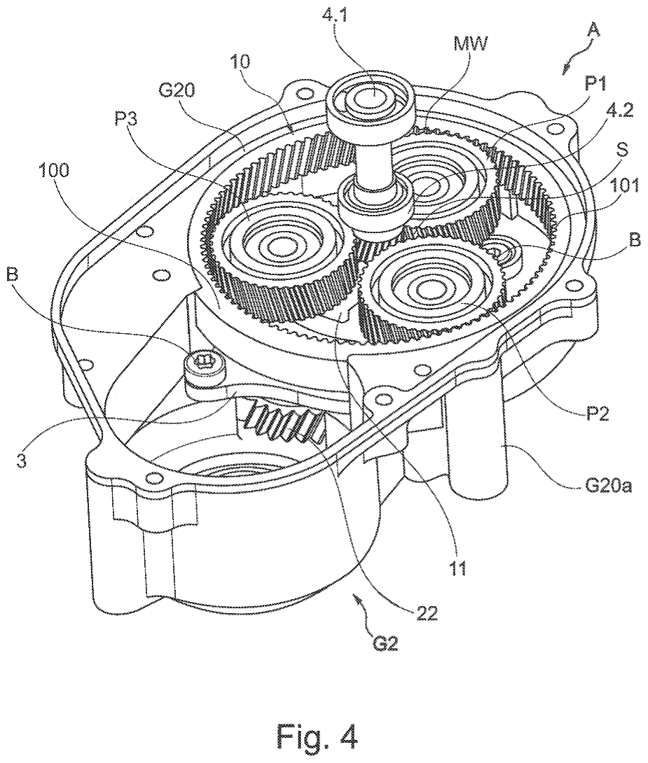

As is illustrated in more detail in particular with reference to FIG. 4, the ring gear 10 however is not completely circumferentially radially supported by a housing-side bearing edge G20 in the second housing half G2. Rather, a cutout G20a is provided in the bearing edge G20, in which a cantilevered support portion 100 of the ring gear 10 is non-rotatably accommodated. As no housing-side radial support is provided on the support portion 100 of the ring gear 10, additional installation space is available in the interior space I of the housing G and a center distance between the individual gear stage axes of rotation and in particular the gear stage axes of rotation L1 and L2, about which the first spur gear 21 and the second spur gear 22, respectively, are rotatable, can be reduced. A center distance between the motor shaft MW and hence the sun gear S of the planetary transmission 1 to the output shaft AT thereby is also limited less strongly by the outside diameter of the ring gear 10. The support portion 100 at the ring gear 10 is provided especially in a region of the ring gear 10 which, with respect to the axis of rotation of the motor shaft MW, is located in a radial direction between the second gear stage axis of rotation L1 and the third gear stage axis of rotation L3.

In order to achieve here the same component rigidity on the entire circumference of the ring gear 10, a circumferential edge of the ring gear 10 is locally thickened at the cantilevered support portion 100. At the support portion 100, an outside diameter of the ring gear 10 thus is locally increased with respect to the further portions of the circumferential edge of the ring gear 10, which are press-fitted at the housing half G2.

For weight reduction, the illustrated ring gear 10 can be made of aluminum or include a metal core overmolded with plastic material, wherein the plastic material then in particular forms the internal toothing 101 of the ring gear 10.

The gear shaft 110 of the planet carrier 11 together with the first spur gear 21 non-rotatably fixed thereto is rotatably mounted on a plate-shaped gearing support 3 of the drive unit A within the interior space I of the housing G. The plate-shaped gearing support 3 is fixed to the second housing half G2 via a plurality of fastening elements B, for example screws (see also FIGS. 2, 3 and 4). A portion of the gearing support 3, which includes a bearing opening 34, extends between a carrier portion of the planet carrier 11 carrying the planet carriers P1, P2 and P3, from which the gear shaft 110 centrally protrudes in an axial direction, and the external toothing of the first spur gear 21. In the bearing opening 34, there is held an anti-friction bearing 4.3, here likewise in the form of a ball bearing, via which the gear shaft 110 and the first spur gear 21 are rotatably mounted. An inner race of the anti-friction bearing 4.3 is provided on a sleeve-shaped first bearing portion 210a of the first spur gear 21 axially extending in the direction of the sun gear S, through which the gear shaft 110 extends. At a shaft end of the gear shaft 110 pointing away from the carrier portion of the planet carrier 11, the gear shaft 110 is accommodated in a further, likewise axially extending sleeve-shaped bearing portion 210b of the first spur gear 21. With the second bearing portion 210b, the shaft end of the gear shaft 110 protrudes into a bearing seat G24 of the housing half G2 formed on the side of the interior space. In this bearing seat G24 a further anti-friction bearing 4.4 is held, whose inner race is provided on the sleeve-shaped second bearing portion 210b of the first spur gear 21. In this way, the gear shaft 110 of the planet carrier 11 is rotatably mounted on the gearing support 3 on the one hand and on the housing half G2 on the other hand.

In the present case, the gearing support 3 furthermore also supports the second spur gear 22 of the spur-gear transmission 2. For this purpose, the gearing support 3 forms an axially protruding bearing pin 35 protruding axially along the second gear stage axis of rotation L2 in the direction of a housing outer wall G27 of the second housing half G2. What sits on this bearing pin 5 is an anti-friction bearing 5, here in the form of a needle bearing, via which the second spur gear 22 is rotatably mounted on the bearing pin 35.

The bearing pin 35 is fixed to the housing wall G27 via a bearing screw 7 accessible from outside the housing G. The bearing screw 7 here is turned into a bore of the bearing pin 35 from outside the housing G through a through opening in the housing wall G27. In this way, the bearing pin 35 of the gearing support 3 is fixed and supported on the housing wall G27. For the additional (pre-) positioning in particular during the assembly of the drive unit A, an inner race 50 of the bearing 5 protrudes into a cutout on an inside of the housing wall G27.

A ribbing R is provided on the outside of the housing wall G27. This ribbing R serves to increase the rigidity of the portion of the housing wall G27 facing the bearing pin 35, and to support the bearing screw 7 on the housing wall G27 with regard to the loads acting on the second spur gear 22 and hence on the bearing pin 35 in operation of the drive unit A.

FIG. 2 in particular illustrates the compact construction of the gearing device 1, 2 of the illustrated drive unit A with its three shaft trains and the three gear stage axes of rotation L1, L2 and L3 connected thereto. Here, it is also again illustrated how with a comparatively large total gear ratio of about 25 between the electric motor E and the output shaft AT comparatively few mechanically cooperating transmission components are needed in the drive unit A, in particular by integrating additional functions in particular components, such as the bearing shield 8 and the gearing support 3. Moreover, there is also shown the above-mentioned comparatively small distance between the different gear stage axes of rotation L1, L2 and L3, which among other things is due to the formation of the stationary ring gear 10 with the cantilevered support portion 100. The bottom bracket shaft T, which together with the output shaft AT is rotatably mounted in the housing G via bearings 6.1 and 6.2, seems to be comparatively short as compared to the drives for electric bicycles known from practice, as the axial dimensions of the drive unit A can be kept slim.

Due to the helical toothing of the gear wheels S, P1 to P3 and 10 of the planetary transmission 1, which are meshing with each other, and of the gear wheels 21 to 23 of the spur-gear transmission 2, the gearing device 1, 2 of the illustrated drive unit A operates comparatively silently.

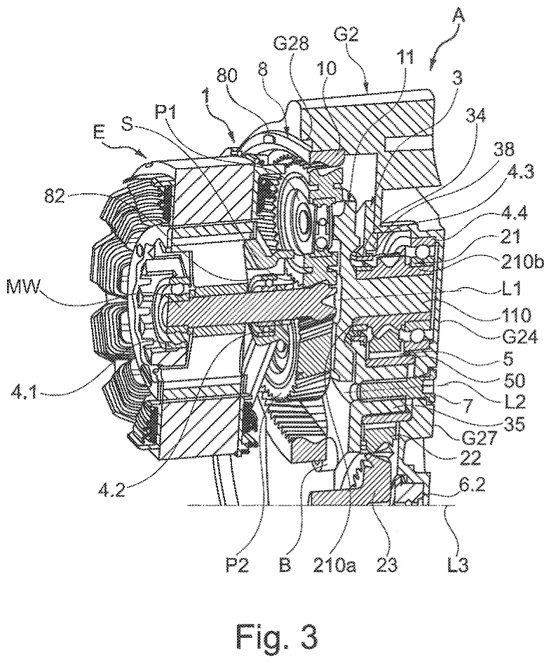

The sectional representation of FIG. 3 in particular again illustrates the arrangement of the plate-shaped gearing support 3 in the interior space I of the housing G and its bearing function both for the planet carrier 11 and the first spur gear 21 and for the second spur gear 22 of the spur-gear transmission 2.

FIG. 3 furthermore illustrates an axially protruding positioning web 38 on the gearing support 3, via which the gearing support 3 is centered with respect to the second housing half G2 and in particular the first gear stage axis of rotation L1, before a fixation of the gearing support 3 to the second housing half G2 is effected via the fastening elements B. The centering of the gearing support 3 within the second housing half G2 can also be supported via the bearing pin 35. The bearing 5 with an axially protruding inner race 50 already is mounted on the bearing pin 35, before the gearing support 3 is mounted on the second housing half G2. The protruding portion of the inner race 50 can then be inserted into the bearing seat formed with the through opening for the bearing screw 7 on the side of the interior space on the inside of the housing wall G27.

The perspective view of FIG. 4 shows the second housing half G2 with the ring gear 10 press-fitted therein, whose cantilevered support portion 100 is non-rotatably accommodated in the cutout G20a. FIG. 4 in particular also clearly illustrates how the center distance between the gear stage axes of rotation L1, L2 and L3 is kept small due to the cantilevered support portion 100 of the ring gear 10. The outside diameter of the second spur gear 22 already is located at the height of the outer shell surface of the ring gear 10.

FIG. 5 shows the other, first housing half G1 in which the electric motor E is accommodated, with the bearing shield 8 attached thereto and the adjoining board 9 (arranged between the electric motor E and the bearing shield 8). The top view of FIG. 5 onto the open side of the first housing half G1 in particular shows a bearing opening G16 which is provided for the bottom bracket shaft T extending through the housing G in the mounted state of the drive unit A. Furthermore, FIG. 5 shows screw points G12 for fixation to the other housing half G2, which in the region of the separating plane T are distributed on a circumference of the first housing half G10.

The drive unit A shown in FIGS. 1 to 5 with a three-stage transmission concept is characterized by an extremely compact construction. In the merely two-part housing G of the drive A the electric motor E is accommodated together with the planetary transmission 1 and the spur-gear transmission 2, wherein by an additional functional integration into a bearing shield 8 and a gearing support 3 the demand of installation space and the weight are reduced with respect to drive units for electric bicycles commonly used in practice. An efficient and comparatively easy assembly of the drive unit A nevertheless are ensured so that both an assembly process and a disassembly process, for example for maintenance purposes, are found to be extremely efficient.

### LIST OF REFERENCE NUMERALS

1 planetary transmission
10 ring gear
100 support portion
101 internal toothing
11 planet carrier
110 gear shaft
2 spur-gear transmission
21 first spur gear
210a, 210b bearing portion
22 second spur gear/intermediate gear
23 third spur gear
3 gearing support
34 bearing opening
35 bearing pin (spur gear bearing portion)
38 positioning web
4.1-4.4 bearing
5 bearing
50 inner race
6.1, 6.2 bearing
7 bearing screw
8 bearing shield
80 centering collar (centering portion)
82 bearing opening
83a, 83b, 83c surface portion
9 board
90 sensor
A drive unit
AT output shaft
B fastening element
E electric motor
G housing
G1, G2 housing half (housing part)
G12 screw point
G16 bearing opening
G18, G28 centering shoulder
G20 bearing edge
G20a cutout
G24 bearing seat
G27 housing outer wall
I interior space
L1, L2, L3 (gear stage) axis of rotation
MW motor shaft
P1, P2, P3 planetary gear
R ribbing
S sun gear
T bottom bracket shaft (drive shaft)
TE separating plane

1. A drive unit for an electric bicycle, comprising
a drive shaft for muscle-powered generation of a driving torque,
an output shaft for driving a wheel of the electric bicycle, the output shaft being arranged coaxially to the drive shaft,
an electric motor with a motor shaft for externally power-operated generation of an additional driving torque,
a gearing device for coupling a motor shaft of the electric motor to the output shaft, wherein the gearing device comprises at least two gear stages, and
a housing accommodating the electric motor and the gearing device,
wherein
the drive unit comprises a gearing support fixed in the housing, on which gearing support at least one gear wheel of a first gear stage and at least one gear wheel of a second gear stage are rotatably mounted.

2. The drive unit according to claim 1, wherein the first gear wheel includes a first bearing portion axially extending with respect to an axis of rotation of the first gear wheel, which first bearing portion protrudes into the bearing opening of the gearing support and on which an anti-friction or plain bearing held in the bearing opening is provided.

3. The drive unit according to claim 2, wherein the first gear wheel includes a second bearing portion axially extending with respect to an axis of rotation of the first gear wheel, which second bearing portion in addition is rotatably mounted on a portion of a housing of the drive unit.

4. The drive unit according to claim 1, wherein the gearing support includes a bearing pin on which the second gear wheel is rotatably mounted.

5. The drive unit according to claim 4, wherein on the bearing pin an anti-friction or plain bearing is provided for rotatably mounting the second gear wheel.

6. The drive unit according to claim 1, wherein the gearing support is plate-shaped.

7. The drive unit according to claim 4, wherein the gearing support is plate shaped and the bearing pin on the plate-shaped gearing support protrudes in the direction of a housing outer wall of the housing.

8. The drive unit according to claim 7, wherein the bearing pin is fixed to the housing outer wall via an arresting element accessible from outside the housing.

9. The drive unit according to claim 1, wherein the gearing support includes a bearing opening for rotatably mounting a gear shaft connected to the first gear wheel.

10. The drive unit according to claim 9, wherein at least one of an anti-friction or plain bearing is held in the bearing opening of the gearing support for rotatably mounting the gear shaft, and the hear shaft additional is rotatably mounted on a portion of a housing of the drive unit

11. (canceled)

12. The drive unit according to claim 1, wherein the gearing device for the first gear stage comprises a planetary transmission with a sun gear, a ring gear and a plurality of planetary gears rotatably mounted on a planet carrier of the planetary transmission, wherein the motor shaft of the electric motor is connected to the sun gear of the planetary transmission, and via the stationary ring gear a torque can be transmitted from the motor shaft to the planet carrier which is connected to the first gear wheel.

13. The drive unit according to claim 12, wherein the gearing device for the second gear stage comprises a spur-gear transmission for transmitting a torque from the planetary transmission to the output shaft, wherein
the first gear wheel is formed by a first spur gear of the spur-gear transmission,
the second gear wheel is formed by a second spur gear of the spur-gear transmission, which second spur gear meshes with the first spur gear and a third spur gear of the spur-gear transmission, and
the third spur gear forms a third gear stage and is connected to the output shaft.

14. The drive unit according to claim 12, wherein on the gearing support the planet carrier of the planetary transmission also is rotatably mounted.

15. The drive unit according to claim 9 claim 14, wherein the gearing device for the first gear stage comprises a planetary transmission with a sun gear, a ring gear and a plurality of planetary gears rotatably mounted on a planet carrier of the planetary transmission, wherein the motor shaft of the electric motor is connected to the sun gear of the planetary transmission, and via the stationary ring gear a torque can be transmitted from the motor shaft to the planet carrier which is connected to the first gear wheel, wherein on the gearing support the planet carrier of the planetary transmission also is rotatably mounted and the gear shaft is part of the planet carrier of the planetary transmission.

16. The drive unit according to claim 12, wherein the stationary ring gear is mounted in the housing, but, with respect to an axis of rotation of the sun gear, is merely partly radially supported circumferentially by the housing.

17. The drive unit according to claim 1, wherein via the gearing device a total gear ratio in the range of 22 to 27 is provided.

18. The drive unit according to claim 1, wherein intermeshing gear wheels of the gearing device are helically toothed.

19. The drive unit according to claim 1, wherein the housing comprises two housing parts connected to each other along a separating plane, and on the separating plane a bearing shield with a bearing opening for rotatably mounting the motor shaft is provided.

20. The drive unit according to claim 19, wherein at least one of the bearing shield integrates a cooling shield for dissipating heat from the interior space of the housing to a housing outer wall, and the bearing shield is arranged adjacent to a board of the drive unit in an interior space of the housing.

21. (canceled)

22. An electric bicycle with a drive unit according to claim 1.
